(19) United States
(12) Patent Application Publication
(10) Pub. No.: US 2007/0126234 A1
(43) Pub. Date: Jun. 7, 2007

(54) Clamp

(76) Inventors: Georg Wirth, Kirchhein/Teck (DE); Felix Neumann, Esslingen (DE)

Correspondence Address: PLEVY & HOWARD & DARCY P.C., P.O. BOX 226, Fort Washington, PA, 19034, US

(21) Appl. No.: 11/604,581

(22) Filed: Nov. 27, 2006

(30) Foreign Application Priority Data
Dec. 1, 2005 (DE) 10 2005 057 670.2

(51) Int. Cl. F16L 23/00

(52) U.S. Cl. 285/410

(57) ABSTRACT

A clamp joins two tubular bodies that are in contact with one another with radially protruding flanges. The clamp has a tensioning section for clamping the clamp in the circumferential direction, a tensioning device for introducing tensile forces oriented in the circumferential direction into the tensioning section, bridging a radial clamp opening in the circumferential direction and a holding section which reaches around the flange in the circumferential direction in the installed state, is attached to the flange on the outside radially and extends around it axially on both sides, clamping them axially against one another. The holding section may be formed by several spring elements that act axially and are arranged side-by-side in the circumferential direction and may be designed and dimensioned so that they are capable of following thermally induced expansions and shrinkage of the flanges with spring elasticity in the installed state of the clamp.

### FIELD OF THE INVENTION

The present invention relates to a clamp for joining two tubular bodies that are in contact with one another axially with flanges protruding radially on the ends.

### BACKGROUND OF THE INVENTION

In a number of applications, tubular bodies, e.g., pipes and pipe sections, must be joined together at axial ends. To do so, the tubular bodies may be provided on their axial ends with radially protruding flanges, which are expediently identical in design and are in contact axially. With the help of clamps, the tubular bodies can be joined together in the area of the flanges inexpensively and with sufficient strength in a time-saving manner. To do so, a clamp usually has a tensioning section which serves to apply tension to the clamp in the circumferential direction and which has a tensioning device. The tensioning device serves to introduce tensile forces oriented in the circumferential direction into the tensioning section and it bridges a radial clamp opening in the circumferential direction. In addition, such a clamp includes a holding section which extends around the flanges in the circumferential direction in the installed state, is attached to the outside of the flanges radially and extends over it axially on both sides and clamps the flanges axially against one another.

The holding section may essentially be designed so that it has a V-shaped profile in the circumferential direction, so that the holding section is closed in a shell-shaped form around the flanges. The flanges are usually also conically shaped, so that the flanges abutting against one another also have a V-shaped profile in the circumferential direction. The circumferential bracing of the tensioning section leads to a radially inner-directed tension of the holding section. Axial tension on the flanges can be achieved by coordinating the V-shaped profile of the holding section and the flanges.

In applications in which the pipes are exposed to high temperature fluctuations because of the medium carried in the pipes, i.e., so-called thermal shock, there is thermally induced expansion and/or shrinkage of the pipes and/or the flanges prior to a corresponding expansion and/or shrinkage of the clamp. Therefore, comparatively high forces may act on the clamp. In the extreme case, these forces may lead to plastic deformation of the clamp. Subsequently, there is a decline in the axial pressure of the flanges that can be achieved with the clamp, so this has a deleterious effect on the imperviousness of the pipe connection created with the help of the clamp.

Applications for such clamps at risk of thermal shock include those in the exhaust systems of internal combustion engines, in particular in motor vehicles, where the thermal shock effects are more pronounced, the closer the respective pipe connection is located in relation to the internal combustion engine. Therefore, clamps with which an exhaust bend is connected to the remaining exhaust line are at particular risk.

### SUMMARY OF THE INVENTION

This invention is based on the general idea of forming a holding section with the help of spring elements that act axially and are arranged side-by-side in the circumferential direction and are also designed and/or dimensioned so that in the installed state of the clamp, they are able to follow thermally induced expansion and/or shrinkage of the flange with spring elasticity. Due to the use of spring elements whose elasticity range includes the entire expansion range and/or shrinkage range of the flange normally to be expected, plastic deformation of the clamp can be avoided in states of thermal shock. The functionality of the clamp is thus preserved. In particular, the pipe connection established with the clamp remains impervious.

In order for the spring elements to have the desired spring elasticity, the spring elements are expediently designed so that their elastic bending deformation takes place more or less two-dimensionally.

The spring elements do not have an excessive extent in the circumferential direction because the bending deformation in the respective profile of the holding section becomes more or less three-dimensional due to such an excessive extent in the circumferential direction, in which case the bulging effects associated with this can lead to plastic deformation. In a preferred embodiment, the spring elements cover up to a maximum 20% or maximum 15% or maximum 10% of the total circumference of the holding section in the circumferential direction.

In another embodiment of the invention, each spring element may have a C-profile or an Ω-profile in the circumferential direction. This makes it possible to achieve an intense axial bracing on the one hand, while on the other hand a comparatively high elastic springiness in the axial direction is ensured.

It is self-evident that the features mentioned above and those yet to be explained below may be used not only in the particular combination given but also in other combinations or alone without going beyond the scope of the present invention.

### BRIEF DESCRIPTION OF THE DRAWINGS

Preferred exemplary embodiments of the invention are depicted in the drawings and explained in greater detail in the following description, where the same reference numerals are used to refer to the same or similar or functionally identical components.

FIG. 1 is a perspective view of a clamp;

FIG. 2 is an axial view of the clamp;

FIG. 3 is a radial view of the clamp according to the direction of view III in FIG. 2;

FIG. 4 is an axial section through the clamp corresponding to sectional line IV in FIG. 2;

FIG. 5 is a radial view of the clamp corresponding to the direction of view V in FIG. 2;

FIG. 6 is a cross section through the clamp corresponding to sectional lines VI in FIG. 5;

FIG. 7 is an axial view of a partial area of another embodiment of the clamp;

FIG. 8 is a cross section through the clamp corresponding to sectional lines Vil in FIG. 7; and

FIG. 9 is a simplified cross section like that in FIG. 8, of another embodiment and in the installed state.

### DETAILED DESCRIPTION OF THE INVENTION

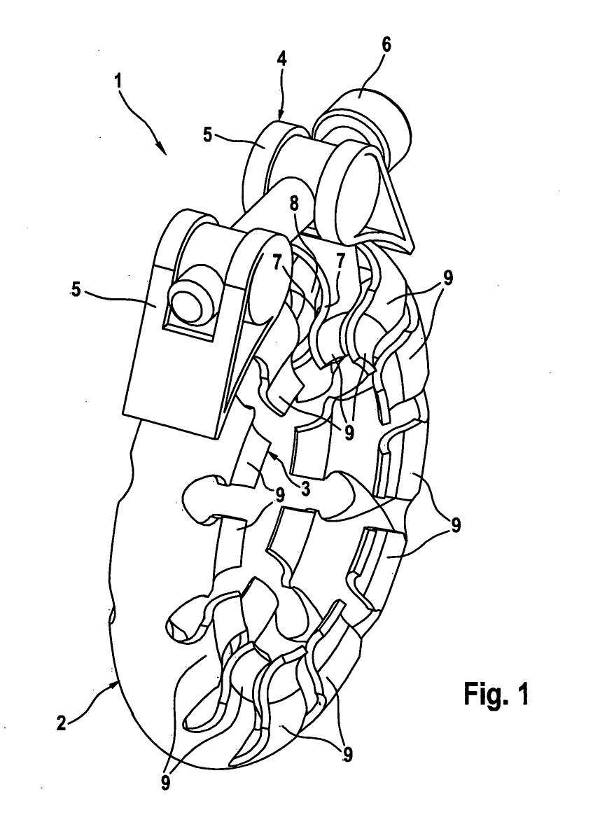

Referring to FIGS. 1 through 9, a clamp 1 comprises a tensioning section 2 that is arranged radially on the outside and extends in the circumferential direction as well as a holding section 3 which also extends in the circumferential direction and is arranged on the inside radially. Now referring to FIG. 9, the clamp 1 connects two tubular bodies 17, 18, each of which has on its axial ends a radially protruding flange 19, 20, these flanges being in contact with one another axially so they are essentially identical in size for joining the tubular bodies 17, 18. The clamp 1 may be used to establish pipe connections in an exhaust system of an internal combustion engine. An application near the engine is preferred, e.g., for connecting an exhaust bend to an exhaust line of the exhaust system.

The tensioning section 2 serves to apply tension to the clamp 1 in the circumferential direction, to which end it has a tensioning device 4 according to FIGS. 1 through 6. With the help of the tensioning device 4, tensile forces oriented in the circumferential direction can be introduced into the tensioning section 2. The tensioning device 4 includes two fittings 5, which are designed here as straps, and a tensioning element 6 in the manner of a threaded bolt. By rotating the tensioning element 6, the fittings 5 can be adjusted against one another, which leads to the desired introduction of force in the circumferential direction in the installed state of the clamp 1. The fittings 5 are each attached to one circumferential end 7 of the clamp 1 and/or one end of the tensioning section 2 on the tensioning section 2, e.g., by soldering or welding. The circumferential ends are opposite one another in the circumferential direction in a radial clamp opening 8. This clamp opening 8 is bridged in the circumferential direction by the tensioning device 4.

The holding section 3 is formed by several spring elements 9 that are arranged side-by-side in the circumferential direction and act axially and thus in parallel on the whole. The design and dimensioning of these spring elements 9 may be selected in a targeted manner to allow them to follow at least the axial elongation and shrinkage of the aforementioned flanges 19, 20 with spring elasticity; such elongation and shrinkage may occur in the flanges 19, 20 because of temperature fluctuations in the media present or conveyed in the tubular bodies 17, 18. For use of the clamp 1 to establish a pipe connection near the engine, this means that in startup of the internal combustion engine, the relatively great expansion of the tubular bodies and thus of the flanges 19, 20 owing to the hot exhaust flow can be compensated by the spring elements 9 of the clamp 1 in the elastic elongation range, so that no plastic deformation occurs in particular and therefore there is no damage to the clamp 1.

In the embodiments shown here, the spring elements 9 are designed and dimensioned so that the axial movements or deformations of the spring elements 9 induced by the thermally induced changes in size of the flanges 19, 20 are more or less two-dimensional bending deformations, which are characterized by a comparatively high elasticity and especially by a comparatively great elasticity range, so the spring elements 9 are able to tolerate elastically comparatively great bending deformations. In the embodiment in FIGS. 1 through 6, the individual spring elements 9 are designed in the manner of plate springs that operate essentially two-dimensionally.

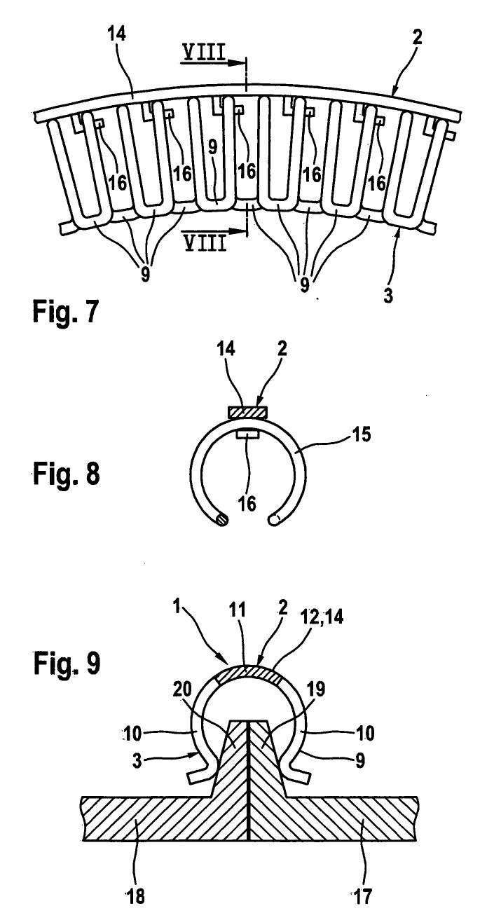

The two-dimensionality of the bending deformation is achieved with the spring elements due to the fact that, among other things, they each extend along only a comparatively small partial section of the total circumference of the holding section 3 in the circumferential direction. For example, the spring elements 9 extend at most along 20% of said total circumference. The maximum extent of the spring elements preferably amounts to 15% or 10% along said total circumference. In the embodiment illustrated in FIGS. 1 through 6, twelve spring elements 9 are arranged and distributed in the circumferential direction so that each individual spring element 9 covers less than 10% of the total circumference of the holding section 3. In the embodiment illustrated in FIGS. 7 and 8, essentially more spring elements 9 are present so that the circumferential extent of the individual spring elements 9 may by no means be less than 5% of the total circumference of the holding section 3.

As indicated by FIG. 4 in particular, the spring elements 9 may have an Ω-shaped profile in the circumferential direction, at least in the uninstalled state of the clamp 1 shown here. The Ω-shaped profile of the spring elements 9 facilitates the mounting of the clamp 1 on the flanges 19, 20 because the clamp 1 here must be attached radially from the outside with its holding section 3 onto the flanges 19, 20. Likewise, the spring elements 9 may also have a C-shaped profile.

According to FIG. 4, the spring elements 9 have two legs 10 in profile extending from a base section 11. An integral design is preferred here in which the legs 10 and the respective base section II develop integrally one into the other.

In the embodiment in FIGS. 1 through 6, a common base 12, which extends in the circumferential direction and is formed by the fact that the base sections 11 of the spring elements 9 develop integrally into one another in the circumferential direction, is present for all spring elements 9.

In this embodiment, the shared base part 12 also forms an integral component of the tensioning section 12 which acts as a tension belt and on which the tensioning device 4 is designed. The tension belt labeled as 14 below, i.e., the common base 12, can transmit the tensile forces induced via the tensioning device 4 into the tensioning section 2 between the circumferential ends 7 of the tensioning section 2 and/or the clamp 1 in the circumferential direction. In this embodiment, the tension belt 14 of the tensioning section 2 is thus formed by the common base 12 of the holding section 3, so this yields an integral design for the tensioning section 2 and the holding section 3.

Essentially a different embodiment is also possible, whereby the tensioning section 2, in particular its tension belt 14, is manufactured separately from the holding section 3 and/or separately from the spring elements 9 (see below with regard to FIGS. 7 and 8).

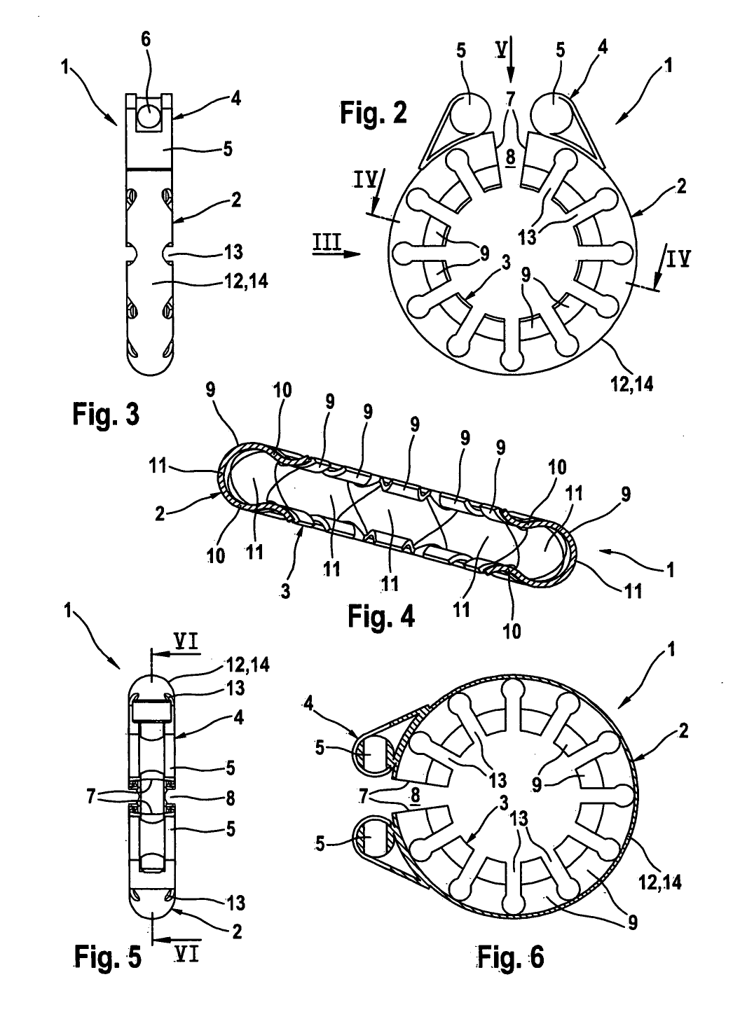

To manufacture the holding section 3 which contains the spring elements 9 as integral components, a clearance 13 is cut or punched between neighboring legs 10, as indicated preferably by FIGS. 2 and 6. To be able to better implement the two-dimensionality of the bending deformation within the individual spring elements 9, the clearances 13 are of such dimensions in the radial direction that they extend to the tension belt 14 of the tensioning section 2. At the same time, this yields the result that the clamp 1 has a comparatively high bending deformability about a bending axis parallel to the axial direction, which simplifies the attachment of the clamp 1 to the flanges 19, 20.

In the embodiment shown in FIGS. 7 and 8, the spring elements 9 are designed to be C-shaped in profile as an example. In this embodiment, an Ω profile is also possible as an alternative. In this embodiment, each spring element 9 is formed by a curved wire 15. The wire 15 is curved to shape the two legs 10 and the respective base section 11 of each spring element 9 (see FIG. 8 in this regard). Referring now to FIG. 7, several neighboring spring elements 9, preferably all the spring elements 9, may be formed with the help of a single wire 15, which is bent in a corresponding manner and develops from one spring element 9 into the next spring element 9 in this way without interruption.

In this embodiment, the tensioning section 2 and the holding section 3 are also separate components which are attached to one another in a suitable manner. The tensioning section 2 here has a separate tension belt 14 accordingly to which the holding section 3 and/or the individual spring elements 9 are attached. The spring elements 9 are attached here to the tension belt 14 via the wire 15 and/or via the base sections 11. For example, corresponding holding straps 16 may be provided here (as shown in FIGS. 7 and 8) with which the spring elements 9 are attached to the tension belt 14. Essentially, weld spots or soldered connections are also conceivable. The fittings 5 may also be integrated into the tension belt 14 here.

FIG. 9 shows in a simplified diagram the clamp 1 in the installed state in which it joins the two tubular bodies 17, 18 which are thereby in axial contact with one another at the flanges 19, 20 protruding radially at the ends. The holding section here reaches around the flanges 19, 20 in the circumferential direction, is positioned radially on the outside on the flanges 19, 20 and extends axially on both sides beyond the flanges 19, 20. At the same time, the holding section 3 axially braces the two flanges 19, 20 against one another with the help of the spring elements 9.

1. A clamp for joining two tubular bodies which are in contact with one another axially with flanges protruding radially at the ends, comprising:
a tensioning section for applying tension to the clamp in the circumferential direction, comprising:
a tensioning device for introducing tensile forces oriented in the circumferential direction into the tensioning section, bridging a radial clamp opening in the circumferential direction; and
a holding section, which extends around the flanges in the circumferential direction in the installed state, is placed radially on the flanges on the outside and reaches around them axially on both sides and clamps them axially against one another;
wherein said holding section is formed from a plurality of spring elements that act axially and are arranged side-by-side in the circumferential direction;
wherein each said spring element is adapted so that in the installed state of the clamp it is capable of following thermally induced expansion and shrinkage of the flanges with spring elasticity.

2. The clamp according to claim 1, wherein each said spring element covers a maximum of 10% to 20% of the total circumference of the holding section in the circumferential direction.

3. The clamp according to claim 1, wherein each said spring element in the circumferential direction has a profile that is C-shaped or Ω-shaped, at least in the uninstalled state of the clamp.

4. The claim according to claim 1, wherein
each said spring element has a profile in the circumferential direction with first and second legs extending radially away from a base section,
wherein said first and second legs and said base section develop integrally one into the other.

5. The clamp according to claim 4, wherein all said base sections of each of said spring elements develop integrally into one another in the circumferential direction and form a common base for all said spring elements, said common base extending in the circumferential direction.

6. The clamp according to claim 5, wherein said common base forms an integral component of said tensioning section which has said tensioning device and acts as a tension belt and transmits circumferentially the tensile forces introduced by said tensioning device between the ends of said tensioning section adjacent to the clamp opening.

7. The clamp according to claim 4, wherein with each said spring element said base section and said first and second legs are formed by a curved wire.

8. The clamp according to claim 7, wherein more than one of said spring elements are formed by means of a suitably curved wire which develops without interruption from a first spring element into a second spring element.

9. The clamp according to claim 4, wherein said tensioning section has a tension belt that extends in the circumferential direction and includes said tensioning device, transmitting circumferentially the tensile forces introduced by said tensioning device between the ends of said tensioning section adjacent to the clamp opening.

10. The clamp according to claim 9, wherein at least said tension belt is a component manufactured separately with regard to said holding section.

11. The clamp according to claim 9, wherein said spring elements are attached to said tension belt via said wire.

12. The clamp according to claim 9, wherein said spring elements are attached to said tension belt via said base sections of said spring elements.

13. The clamp according to claim 9, wherein said spring elements are attached to said tension belt via said common base.
